(19) United States
(12) Patent Application Publication
(10) Pub. No.: US 2025/0250694 A1
(43) Pub. Date: Aug. 7, 2025

(54) MEMBRANE ELECTRODE ASSEMBLY WITH GRADED GAS RECOMBINATION LAYER

(71) Applicant: GM Global Technology Operations LLC, Detroit, MI (US)

(72) Inventors: Wenbin Gu, Sterling Heights, MI (US); Ruichun Jiang, Troy, MI (US)

(73) Assignee: GM Global Technology Operations LLC, Detroit, MI (US)

(21) Appl. No.: 18/435,067

(22) Filed: Feb. 7, 2024

(51) Int. Cl. C25B 9/23; C25B 1/04; C25B 11/081; C25B 13/02; C25B 13/08; H01M 8/0656

(52) U.S. Cl. CPC C25B 9/23; C25B 1/04; C25B 11/081; C25B 13/02; C25B 13/08; H01M 8/0656; H01M 2250/20

(57) ABSTRACT

A membrane electrode assembly includes a cathode portion disposed on one end and an anode portion disposed on an opposite end from the cathode portion. The membrane electrode assembly also includes a cathode ionomer layer disposed adjacent the cathode portion and an anode ionomer layer disposed adjacent the anode portion. Further, the membrane electrode assembly may include one or more support layers disposed between the cathode ionomer layer and the anode ionomer layer. Additionally, the anode ionomer layer includes a plurality of gas recombination catalysts in a graded dispersion such that a portion of the anode ionomer layer disposed closer to the anode portion includes a higher concentration of gas recombination catalysts than a portion of the anode ionomer layer disposed closer to the cathode portion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a membrane electrode assembly and its use to produce hydrogen in a water electrolyzer.

Membrane electrode assemblies can be used within electrolyzers or other energy storage devices to produce hydrogen fuel. To facilitate this, the membrane electrode assembly of the electrolyzer is configured to use an electric current to split water molecules into hydrogen and oxygen gases, where the hydrogen gas may then be stored as a fuel source for other systems. Many membrane electrode assemblies include a gas recombination layer employed within a membrane to reduce undesirable gas crossover of hydrogen and oxygen during operation due to proton permeation through the membrane.

Current membrane electrode assemblies include dispersing a gas recombination catalyst (GRC) uniformly in the gas recombination layer. However, this distribution of GRC still requires proton migration within the membrane leading to a breakdown of the membrane over time. As such, an improved gas recombination layer for a membrane electrode assembly is needed.

### SUMMARY

In one configuration, a membrane electrode assembly configured to use an electric current to split water molecules into hydrogen and oxygen gases includes a cathode portion disposed on one end. The membrane electrode assembly also includes an anode portion disposed on an opposite end from the cathode portion, a cathode ionomer layer disposed adjacent the cathode portion, and an anode ionomer layer disposed adjacent the anode portion. Further, a support layer may be disposed between the cathode ionomer layer and the anode ionomer layer. Additionally, the anode ionomer layer includes a plurality of gas recombination catalysts in a graded dispersion such that a portion of the anode ionomer layer disposed closer to the anode portion includes a higher concentration of gas recombination catalysts than a portion of the anode ionomer layer disposed closer to the cathode portion.

The membrane electrode assembly may also include one or more of the following optional features. For example, the gas recombination catalysts may be one or more of particles, fibers, or flakes. Additionally, the gas recombination catalysts may be comprised of Platinum. Alternatively, the gas recombination catalysts may be comprised of Palladium. Additionally, the gas recombination catalysts may be a plurality of gas recombination catalysts having varying sizes. Moreover, a second support layer may be disposed between the anode ionomer layer and the anode portion. Alternatively, the anode ionomer layer and the anode portion may be directly adjacent to one another such that a portion of the anode ionomer layer and a portion of the anode portion are in contact with one another. Additionally, an electrolyzer may be produced using the membrane electrode assembly.

In another configuration, a membrane electrode assembly configured to use an electric current to split water molecules into hydrogen and oxygen gases includes a cathode portion disposed on one end and an anode portion disposed on an opposite end from the cathode portion. The membrane electrode assembly also includes a cathode ionomer layer disposed adjacent the cathode portion and an anode ionomer layer disposed adjacent the anode portion. Further, the electrode assembly may include a support layer disposed between the cathode ionomer layer and the anode ionomer layer. Additionally, the anode ionomer layer includes a first portion disposed closer to the anode portion, a second portion disposed closer to the cathode portion, and a third portion disposed between the first portion and the second portion. Moreover, the first portion includes a high concentration of gas recombination catalysts dispersed therein and the third portion includes a low concentration of gas recombination catalyst dispersed therein. Generally, the portion closer to the cathode portion has a lower concentration of gas recombination catalysts.

The membrane electrode assembly may also include one or more of the following optional features. For example, the second or third portion may not include any gas recombination catalysts dispersed therein. Additionally, the gas recombination catalysts may be one or more of particles, fibers, or flakes. Moreover, the gas recombination catalysts may be comprised of Platinum. Additionally, the gas recombination catalysts may be a plurality of gas recombination catalysts having varying sizes. Further, an electrolyzer may incorporate the membrane electrode assembly.

In another configuration, a proton exchange membrane in an electrolyzer includes a cathode ionomer layer disposed on one end and an anode ionomer layer disposed on an opposite end of the cathode ionomer layer. The proton exchange membrane may also include a support layer disposed between the cathode ionomer layer and the anode ionomer layer. Additionally, the anode ionomer layer includes a plurality of gas recombination catalysts in a graded dispersion such that a portion of the anode ionomer layer disposed further from the cathode ionomer layer includes a higher concentration of gas recombination catalysts than a portion of the anode ionomer layer disposed closer to the cathode ionomer layer.

The proton exchange membrane may also include one or more of the following optional features. For example, the gas recombination catalysts may be comprised of Platinum or Palladium. Additionally, the gas recombination catalyst may be one or more of particles, fibers, or flakes. Moreover, the gas recombination catalysts may be a plurality of gas recombination catalysts having varying sizes.

### BRIEF DESCRIPTION OF THE DRAWINGS

The drawings described herein are for illustrative purposes only of selected configurations and are not intended to limit the scope of the present disclosure.

FIG. 1 is a schematic view of an electrolyzer including a membrane electrode assembly according to the present disclosure;

FIG. 2 is a schematic view of one example of the membrane electrode assembly used in the electrolyzer of FIG. 1;

FIG. 3 is a schematic view of another example of a membrane electrode assembly according to the present disclosure;

FIG. 4 is a schematic view of yet another example of a membrane electrode assembly according to the present disclosure;

FIG. 5 is a schematic view of yet another example of a membrane electrode assembly according to the present disclosure; and

FIG. 6 is a schematic view of yet another example of a membrane electrode assembly according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art.

Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube). LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

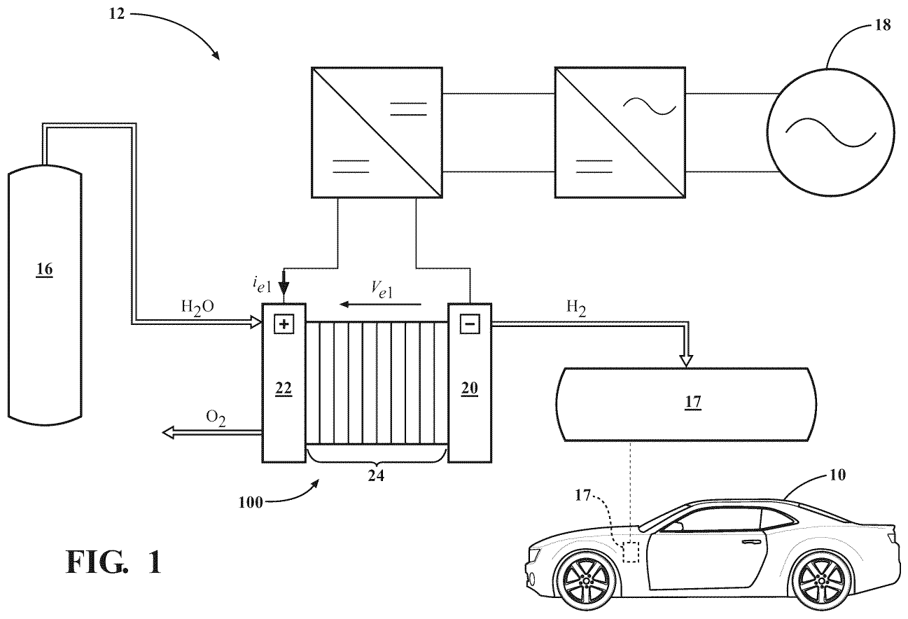

Referring to FIGS. 1-6, a membrane electrode assembly 100 is disclosed. The membrane electrode assembly 100 is configured to use an electric current to split water molecules into hydrogen and oxygen gases. Additionally, the membrane electrode assembly 100 may be incorporated into an electrolyzer 12, as illustrated in FIG. 1. Moreover, the electrolyzer 12 may include a water tank 16, a hydrogen tank 17, and a power source 18 coupled to the membrane electrode assembly 100. More specifically, the membrane electrode assembly 100 uses electricity from the power source 18 to split water from the water tank 16 into oxygen and hydrogen, which is then stored in the hydrogen tank 17. Further, the stored hydrogen may then be used in other applications which use hydrogen fuel, such as a fuel cell electric vehicle 10, as illustrated in FIG. 1.

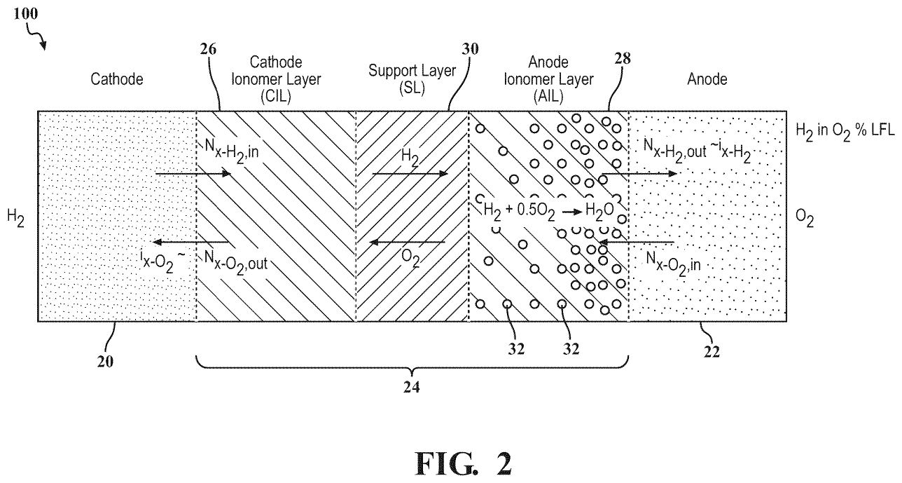

As best shown in FIG. 2, the membrane electrode assembly 100 includes a cathode portion 20 disposed on one end and an anode portion 22 disposed on an opposite end from the cathode portion 20. The cathode portion 20 includes a negatively charged porous electrode by which electrons enter the membrane electrode assembly 100 and within which hydrogen evolution reaction occurs (i.e., a chemical reaction that yields hydrogen). Additionally, the anode portion 22 includes a positively charged porous electrode by which protons enter and electrons leave the membrane electrode assembly 100 and within which oxygen evolution reaction takes place (i.e., a chemical reaction that yields oxygen).

Referring still to the example shown in FIG. 2, the proton exchange membrane 24 is disposed between the cathode portion 20 and the anode portion 22. Generally, the proton exchange membrane 24 may be comprised of a fluoropolymer proton permeable electrical insulator barrier. Alternatively, the proton exchange membrane 24 may be a hydrocarbon proton permeable electrical insulator barrier. Further, the proton exchange membrane 24 serves as a conductor for protons generated at the anode portion 22 to transport to the cathode portion 20 as a reactant for hydrogen evolution reaction. Additionally, the proton exchange membrane 24 may also serve as an insulator for electrons to flow through an external circuit. Moreover, the proton exchange membrane 24 may be comprised of Nafion such Nafion XL, 112, 115, 117, or 1110.

Further, as illustrated in FIG. 2, the proton exchange membrane 24 includes a plurality of layers disposed between the cathode portion 20 and the anode portion 22. For example, the proton exchange membrane 24 may include a cathode ionomer layer 26 and an anode ionomer layer 28. Additionally, the proton exchange membrane may include a support layer 30, if desired. The role of the cathode ionomer layer 26 is to conduct protons through the cathode ionomer layer 26. Additionally, the cathode ionomer layer 26 may be comprised of ionomer nanofiber scaffolding, including polymer materials consisting of thermoplastic resin, which is stabilized by ionic cross-linkages. Moreover, the cathode ionomer layer 26 is disposed adjacent to the cathode portion 20. In the example shown in FIG. 2, the cathode ionomer layer 26 is disposed directly adjacent to the cathode portion 20 such that a portion of the cathode ionomer layer 26 is in contact with the cathode portion 20. However, it is also contemplated that another layer or other portion may be disposed between the cathode portion 20 and the cathode ionomer layer 26.

As best shown in FIG. 2, the proton exchange membrane 24 may also include the support layer 30 disposed between the cathode ionomer layer 26 and the anode ionomer layer 28. If the support layer 30 is included in the proton exchange membrane 24, the proton exchange membrane 24 may be referred to as a composite membrane. The role of the support layer 30 is to provide additional mechanical strength for the proton exchange membrane 24. If the proton exchange membrane 24 itself is mechanically strong, then the support layer 30 may not be required. On the other hand, if needed, multiple support layers 30 may be employed to reinforce the proton exchange membrane 24 further. Additionally, the support layer 30 may be proton conductive and may be comprised of a similar material as the cathode ionomer layer 26. More specifically, the support layer 30 may include an ionomer embedded in a porous reinforced layer. Further, the support layer 30 may also include ionomer nanofiber scaffolding, including polymer materials consisting of thermoplastic resin which is stabilized by ionic cross-linkages.

Additionally, the primary role of the anode ionomer layer 28 is to conduct protons. Moreover, the anode ionomer layer 28 may be comprised of ionomer nanofiber scaffolding, including polymer materials consisting of thermoplastic resin which is stabilized by ionic cross-linkages. Further, as shown in FIG. 2, the anode ionomer layer 28 is disposed adjacent to the anode portion 22. In the example shown, the anode ionomer layer 28 is disposed directly adjacent to the anode portion 22 such that a portion of the anode ionomer layer 28 is in contact with the anode portion 22. However, it is also contemplated that the support layer 30 or other layer may be disposed between the anode portion 22 and the anode ionomer layer 28, as described in more detail below.

Additionally, the anode ionomer layer 28 includes a plurality of gas recombination catalysts 32 configured to recombine stoichiometric amounts of hydrogen and oxygen gas and convert them into water. The gas recombination catalysts 32 may be disposed in a film that is placed on top of the anode ionomer layer 28 as a gas recombination layer, or the gas recombination catalysts 32 may be otherwise disposed on or within the anode ionomer layer 28. Additionally, the anode ionomer layer 28 may contain additives such as a Cerium compound and/or Manganese for chemical stabilization. Further, it is contemplated that additives such as the Cerium compound and/or Manganese may be present in any layer of the proton exchange membrane 24. Additionally, the gas recombination catalysts 32 may include, but are not limited to. Platinum and/or Palladium. Moreover, the gas recombination catalysts 32 may include support materials such as carbon or silica. Additionally, the gas recombination catalysts 32 may be in the form of one or more of particles, fibers, or flakes. Further, the gas recombination catalysts 32 may include varying sizes of particles, fibers, or flakes.

Referring again to the example shown in FIG. 2, the gas recombination catalysts 32 are dispersed through the anode ionomer layer 28 in a graded dispersion, such that a portion of the anode ionomer layer 28 disposed closer to the anode portion 22 includes a higher concentration of gas recombination catalysts 32 than a portion of the anode ionomer layer 28 disposed closer to the cathode portion 20. For example, the portion of the anode ionomer layer 28 disposed closer to the anode 22 than to the support layer 30 or the cathode ionomer layer 26 may include approximately 60-95% of the total amount of gas recombination catalysts 32 in the proton exchange membrane 24. In another example, the portion of the anode ionomer layer disposed closer to the anode 22 may include approximately 70-90% of the total amount of gas recombination catalysts 32 in the proton exchange membrane 24. In yet another example, the portion of the anode ionomer layer 28 disposed closer to the anode 22 may include approximately 80-90% of the total amount of gas recombination catalysts 32 in the proton exchange membrane 24.

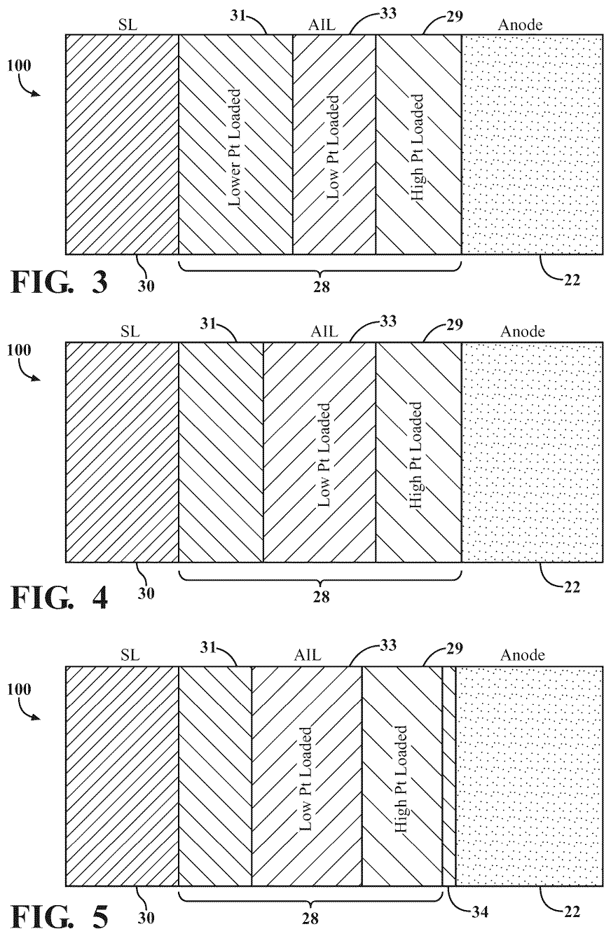

Referring now to the examples shown in FIGS. 3 and 4, similar to the example shown in FIG. 2, the gas recombination catalysts 32 are dispersed through the anode ionomer layer 28 in a graded dispersion, such that a portion of the anode ionomer layer 28 disposed closer to the anode portion 22 includes a higher concentration of gas recombination catalysts 32 than a portion of the anode ionomer layer 28 disposed closer to the cathode portion 20. More specifically, in the examples shown in FIGS. 3 and 4, the anode ionomer layer 28 may include a first portion 29 disposed closer to the anode portion 22, a second portion 31 disposed closer to the cathode portion 20, and a third portion 33 disposed between the first portion 29 and the second portion 31. In this configuration, the first portion 29 includes a high concentration of gas recombination catalysts 32 dispersed therein and the third portion 33 includes a low concentration of gas recombination catalyst 32 dispersed therein. In the example shown in FIG. 3, the second portion 31 includes a level of concentration of the gas recombination catalysts 32 that is generally lower than the level of concentration of the gas recombination catalyst 32 in the third portion 33. Alternatively, in the example shown in FIG. 4, the second portion 31 does not include any gas recombination catalysts 32 dispersed therein.

Referring now to the example shown in FIG. 5, a thin ionomer layer 34 is disposed between the anode ionomer layer 28 and the anode portion 22. When present, the thin ionomer layer 34 is configured to prevent the gas recombination catalysts 32 from exposure to the high electric potential of the anode portion 22 and, thus, reduces the risk of catalyst degradation. Additionally or alternatively, the thin ionomer layer 34 may be configured to provide mechanical support to the membrane 24, similar to the support layer 30 described above.

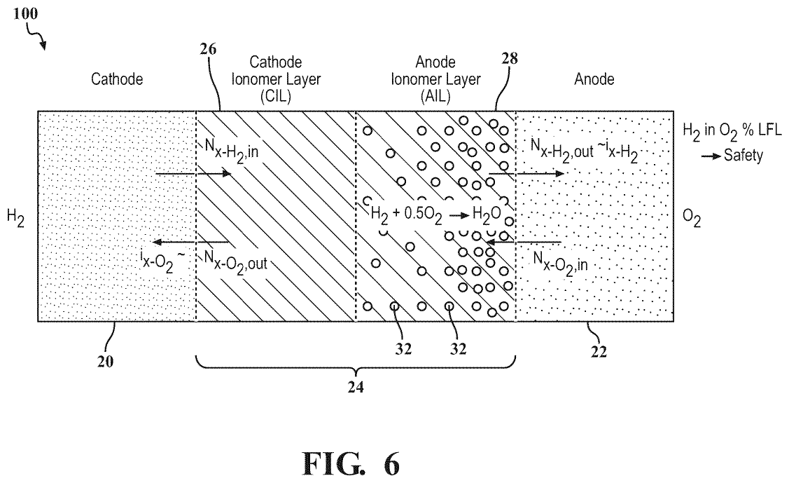

Referring now to the example shown in FIG. 6, the membrane electrode assembly 100 may not include the support layer 30 between the anode ionomer layer 28 and the cathode ionomer layer 26. In other words, in the example shown in FIG. 6, the anode ionomer layer 28 and the cathode ionomer layer 26 are directly adjacent to one another. However, as described above, the anode ionomer layer 28 still includes the graded dispersion of the gas recombination catalysts 32 such that the portion of the anode ionomer layer 28 disposed closer to the anode portion 22 includes a higher concentration of gas recombination catalysts 32 than the portion of the anode ionomer layer 28 disposed further from the anode portion 22.

Having the gas recombination catalysts 32 dispersed through the anode ionomer layer 28 in a graded dispersion, such that the portion of the anode ionomer layer 28 disposed closer to the anode portion 22 includes a higher concentration of gas recombination catalysts 32 than the portion of the anode ionomer layer 28 disposed closer to the cathode portion 20, ensures high utilization of gas recombination catalysts 32 and significantly reduces gas crossover. Therefore, the resulting membrane electrode assembly 100 is more efficient and is safer to operate then previous membrane electrode assemblies.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A membrane electrode assembly configured to use an electric current to split water molecules into hydrogen and oxygen gases, the membrane electrode assembly comprising:
a cathode portion disposed on one end:
an anode portion disposed on an opposite end from the cathode portion; and
a proton exchange membrane disposed between the cathode portion and the anode portion, the proton exchange membrane including:
a cathode ionomer layer disposed adjacent the cathode portion;
an anode ionomer layer disposed adjacent the anode portion; and
a support layer disposed between the cathode ionomer layer and the anode ionomer layer, the anode ionomer layer including a plurality of gas recombination catalysts in a graded dispersion such that a portion of the anode ionomer layer disposed closer to the anode portion includes a higher concentration of gas recombination catalysts than a portion of the anode ionomer layer disposed closer to the cathode portion.

2. The membrane electrode assembly of claim 1, wherein the gas recombination catalysts are one or more of particles, fibers, or flakes.

3. The membrane electrode assembly of claim 1, wherein the gas recombination catalysts are comprised of Platinum.

4. The membrane electrode assembly of claim 1, wherein the gas recombination catalysts are comprised of Palladium.

5. The membrane electrode assembly of claim 1, wherein the gas recombination catalysts are a plurality of gas recombination catalysts having varying sizes.

6. The membrane electrode assembly of claim 1, wherein an ionomer layer free of gas recombination catalysts is disposed between the anode ionomer layer and the anode portion.

7. The membrane electrode assembly of claim 1, wherein the anode ionomer layer and the anode portion are directly adjacent to one another such that a portion of the anode ionomer layer and a portion of the anode portion are in contact with one another.

8. An electrolyzer incorporating the membrane electrode assembly of claim 1 and configured to produce hydrogen fuel.

9. A vehicle incorporating the hydrogen fuel produced by the electrolyzer of claim 8.

10. A membrane electrode assembly configured to use an electric current to split water molecules into hydrogen and oxygen gases, the membrane electrode assembly comprising:
a cathode portion disposed on one end:
an anode portion disposed on an opposite end from the cathode portion; and
a proton exchange membrane extending between the cathode portion and the anode portion, the proton exchange membrane including:
a cathode ionomer layer disposed adjacent the cathode portion; and
an anode ionomer layer disposed adjacent the anode portion, the anode ionomer layer including a first portion disposed closer to the anode portion, a second portion disposed closer to the cathode portion, and a third portion disposed between the first portion and the second portion, the first portion including a high concentration of gas recombination catalysts dispersed therein and the third portion including a low concentration of gas recombination catalyst dispersed therein.

11. The membrane electrode assembly of claim 10, wherein the second portion does not include any gas recombination catalysts dispersed therein.

12. The membrane electrode assembly of claim 10, wherein the gas recombination catalysts are one or more of particles, fibers, or flakes.

13. The membrane electrode assembly of claim 10, wherein the gas recombination catalysts are comprised of Platinum.

14. The membrane electrode assembly of claim 10, wherein the gas recombination catalysts are a plurality of gas recombination catalysts having varying sizes.

15. The membrane electrode assembly of claim 10, wherein the gas recombination catalysts are comprised of Palladium.

16. An electrolyzer incorporating the membrane electrode assembly of claim 10.

17. A proton exchange membrane comprising:
a cathode ionomer layer disposed on one end;
an anode ionomer layer disposed on an opposite end from the cathode ionomer layer; and
a support layer disposed between the cathode ionomer layer and the anode ionomer layer, the anode ionomer layer including a plurality of gas recombination catalysts in a graded dispersion such that a portion of the anode ionomer layer disposed further from the cathode ionomer layer includes a higher concentration of gas recombination catalysts than a portion of the anode ionomer layer disposed closer to the cathode ionomer layer.

18. The proton exchange membrane of claim 17, wherein the gas recombination catalysts are comprised of Platinum.

19. The proton exchange membrane of claim 17, wherein the gas recombination catalysts are one or more of particles, fibers, or flakes.

20. The proton exchange membrane of claim 17, wherein the gas recombination catalysts are a plurality of gas recombination catalysts having varying sizes.
